(19) United States
(12) Patent Application Publication
(10) Pub. No.: US 2009/0051540 A1
(43) Pub. Date: Feb. 26, 2009

(54) ANTI-FAKE PACKAGING MATERIAL OF RFID AND ITS PACKAGING METHOD

(76) Inventors: I-Ju FU, Longtan Shiang (TW); Yung-Chih Lo, Pusin Township (TW); Yao-Jen Chen, Fongshan City (TW)

Correspondence Address: SINORICA, LLC, 528 FALLSGROVE DRIVE, ROCKVILLE, MD, 20850, US

(21) Appl. No.: 12/176,509

(22) Filed: Jul. 21, 2008

(30) Foreign Application Priority Data
Aug. 22, 2007 (TW) 096131034

(51) Int. Cl. G08B 13/14

(52) U.S. Cl. 340/572.7

(57) ABSTRACT

A RFID packaging material packaging method includes the steps of: providing a substrate having a conductive layer covered thereon, processing the conductive layer of the substrate to form an antenna, electrically connecting a chip to the antenna via a pad, and covering the substrate onto a product for enabling the product to provide a RFID recognition function. The invention relates also to the RFID packaging material made subject to this RFID packaging material packaging method.

### BACKGROUND OF THE INVENTION

1. Field of the Invention

The present invention relates to a radio frequency anti-fake packaging material and its packaging method, which uses the inner packaging material of a product as the substrate and has the antenna directly formed in the substrate, thereby saving the manufacturing cost.

2. Description of the Related Art

In order to get a high profit, many evil persons provide fake products to cheat consumers, threatening the safety of human life and property. Counterfeit packages of cigarettes are widely seen on market, causing the real manufacturers to suffer big loss. Further, counterfeit packages of cigarettes commonly have a bad quality that threatens consumers' health. Therefore, an anti-fake measurement in this regard is an urgent problem.

A RFID (radio-frequency identification) tag is to be applied to or incorporated into a product for the purpose of identification using radiowaves. A RFID tag can record product provider, manufacturing process, product flow quality, and etc., for different control purposes. By means of a specific code, a RFID tag provides an anti-fake function.

FIG. 1 illustrates a RFID tag incorporated into a package of cigarettes according to the prior art. As illustrated, the RFID tag 100 is directly adhered to the outer surface of the cigarette package 140. The RFID tag 100 comprises a substrate 110, an antenna circuit 120, and a chip 130. The substrate 110 and the antenna circuit 120 take about 70% of the cost of the RFID tag 100 while the rest 30% is for the chip 130. During application, the shielding effect of the internal aluminum foil 150 of the cigarette package 140 limits the reading distance of the RFID scanner. Further, because the cost for the substrate 110 and the antenna circuit 120 is about 70% of the total cost of the RFID tag 100, it is difficult to lower the cost of the RFID tag 100.

Therefore, it is desirable to design a cost effective RFID anti-fake packaging material and its packaging method that overcomes the aforesaid problems.

### SUMMARY OF THE INVENTION

The present invention has been accomplished under the circumstances in view. It is the main object of the present invention to provide a RFID packaging material and its packaging method, which uses the inner packaging material of a product as the substrate and has the antenna directly formed in the substrate, thereby saving the manufacturing cost.

It is another object of the present invention to provide a RFID packaging material and its packaging method, which uses the inner packaging material of a product as the substrate and has the antenna directly formed in the inner packaging material to prevent a shielding effect during of the RFID tab by a RFID scanner at a distance.

To achieve these and other objects of the present invention, the RFID packaging material packaging method comprises the steps of: providing a substrate having a conductive layer covered thereon, processing the conductive layer to form an antenna, mounting a RFID chip in the substrate for electrically connecting the chip to the antenna via a pad, and covering the substrate onto a product.

To achieve these and other objects of the present invention, the RFID packaging material comprises a substrate covered with a metal layer for packaging a product, an antenna formed in the substrate, and a chip electrically connected to the antenna via a pad for receiving and transmitting data.

### BRIEF DESCRIPTION OF THE DRAWINGS

FIG. 1 is a schematic drawing showing a RFID tag incorporated into a cigarette package according to the prior art.

FIG. 2 is a flow chart of a RFID packaging method according to the present invention.

FIG. 3 is a schematic drawing of a RFID packaging material according to the present invention, showing the antenna disposed at the front side.

FIG. 4 illustrates an alternate form of the RFID packaging material according to the present invention, showing the antenna disposed at one lateral side.

FIG. 5 illustrates the RFID packaging material packed inside a cigarette package according to the present invention.

FIG. 6 illustrates the RFID packaging material incorporated into the cap of a bottle according to the present invention.

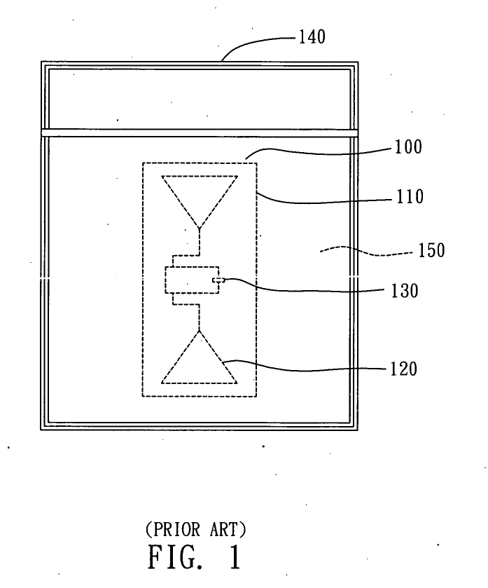

### DETAILED DESCRIPTION OF THE PREFERRED EMBODIMENT

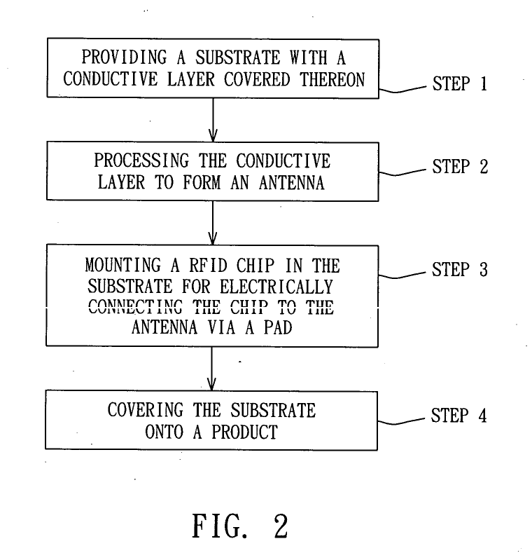

Referring to FIG. 2, a RFID packaging method in accordance with the present invention comprises the steps of: (1) providing a substrate 10 with a conductive layer (not shown) covered thereon, (2) processing the conductive layer of the substrate 10 to form an antenna 11, (3) mounting a RFID chip 20 in the substrate 10 for electrically connecting the chip 20 to the antenna 11 via a pad, and (4) covering the substrate 10 onto a product 30.

In the aforesaid step (1) providing a substrate 10 with a conductive layer covered thereon, the substrate 10 can be an aluminum coated inner packaging material used in a cigarette package, or an aluminum coated packaging paper for bottle wine. Any packaging paper coated with tin or any other metal can also be used.

In the aforesaid step (2) processing the conductive layer of the substrate 10 to form an antenna 11, the substrate 10 is trimmed, etched, stamped or cut subject to a predetermined antenna pattern so as remove a part of the metal layer corresponding to the antenna pattern, thereby providing the desired antenna 11 that does not interfere with the reading of a RFID scanner. The antenna 11 can be, for example, a slot antenna at any location on the substrate 10, for example, at the front or lateral side of the substrate 10 as desired.

During the aforesaid step (3) mounting a RFID chip 20 in the substrate 10 for electrically connecting the chip 20 to the antenna 11 via a pad (not shown). The chip 20 can be, for example, a RFID chip having a specific ID (identification) code. The chip 20 can be electrically connected to the antenna 11 via a pad by an adhesive. Through the antenna 11, the chip 20 is readable by a RFID scanner.

During the aforesaid step (4) covering the substrate 10 onto a product 30, the substrate 10 is packaged inside or on the product 30. The product 30 can be, for example, a cigarette package. When packed, the product 30 has a unique ID.

The RFID packaging method further comprises a step of packaging the substrate in an outer box 40. The outer box 40 can be a hard paper box that protects the substrate 10, the antenna 11, the chip 20, and the product 30.

Therefore, a cigarette manufacturer can cut each inner packaging material (substrate 10) for cigarette package to form an antenna in it, thereby lowering the cost for RFID tag. Because the chip 20 carries a unique ID (identification) code, the authenticity of the product (package of cigarettes) can be recognized by means of a RFID scanner. Therefore, the application of the present invention protects the manufacturer's benefits and consumers' health, and eliminates the drawbacks of the prior art design.

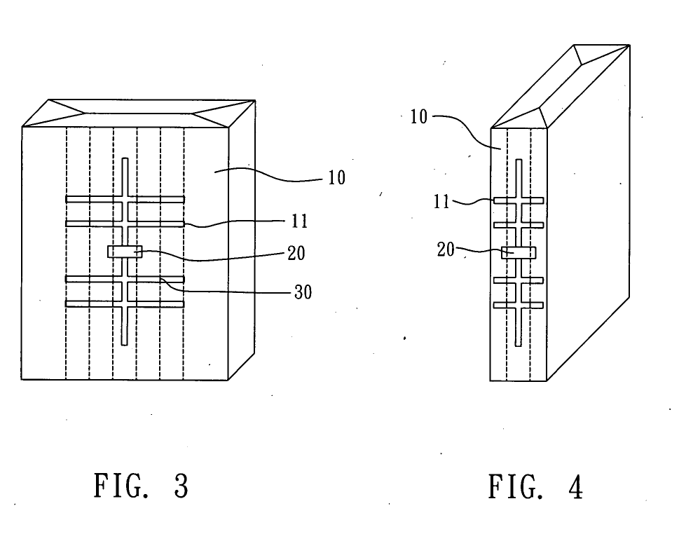

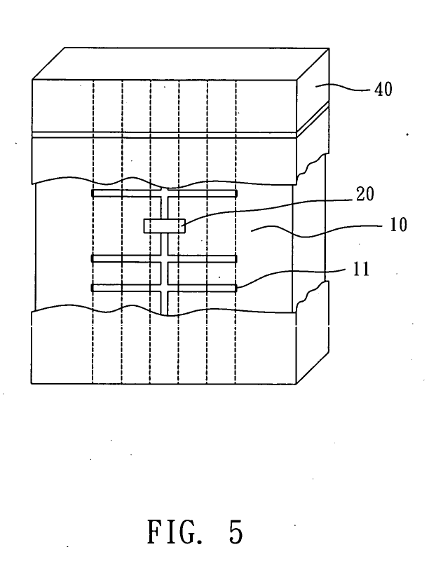

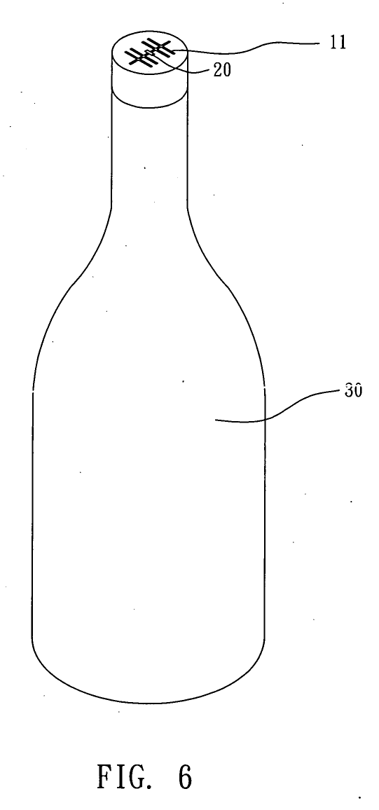

FIG. 3 is a schematic drawing of a RFID packaging material according to the present invention, showing the antenna disposed at the front side. FIG. 4 illustrates an alternate form of the RFID packaging material according to the present invention, showing the antenna disposed at one lateral side. FIG. 5 illustrates the RFID packaging material packed inside a cigarette package according to the present invention. FIG. 6 illustrates the RFID packaging material incorporated into the cap of a bottle according to the present invention. As illustrated in FIGS. 3˜6, the RFID packaging material is comprised of a substrate 10, an antenna 11, and a chip 20.

The substrate 10 covered with a conductive layer (not shown) can be an aluminum coated inner packaging material used in a cigarette package, or an aluminum coated packaging paper for bottle wine. Any packaging paper coated with tin or any other metal can also be used. Further, the substrate 10 is for packaging a product 30, for example, a set of cigarettes.

The antenna 11 is, for example, a slot antenna formed in the substrate 10. The substrate 10 is trimmed, etched, stamped or cut subject to a predetermined antenna pattern so as remove a part of the metal layer corresponding to the antenna pattern, thereby providing the desired antenna 11 that does not interfere with the reading of a RFID scanner. The antenna 11 can be at any location on the substrate 10, for example, at the front (see FIG. 3) or one lateral side of the substrate 10 (see FIG. 4) as desired.

The chip 20 can be, for example, a RFID chip having a specific ID (identification) code. The chip 20 can be electrically connected to the antenna 11 via a pad (not shown) by an adhesive. Through the antenna 11, the chip 20 is readable by a RFID scanner.

By means of a trimming or cutting process, the desired antenna 11 is formed in the substrate 10. After electrically connecting the chip 20 to the antenna 11 via a pad, the substrate 10 is wrapped about a predetermined number of cigarettes 30. Thus, the chip 20 at the substrate 10 provides the cigarettes 30 with a unit ID (identification) code.

The RFID packaging material is then packed in an outer box 40. The outer box 40 can be a hard paper box that protects the substrate 10, the antenna 11, the chip 20, and the product 30.

According to the present invention, a cigarette manufacturer can cut each inner packaging material (substrate 10) for cigarette package to form an antenna in it, thereby lowering the cost for RFID tag. Because the chip 20 carries a unique ID (identification) code, the authenticity of the product (package of cigarettes) can be recognized by means of a RFID scanner. Therefore, the application of the present invention protects the manufacturer's benefits and consumers' health, and eliminates the drawbacks of the prior art design.

Because the antenna 11 is directly formed in the substrate 10 by means of a trimming or cutting process, the cost of the RFID packaging material is low. Because the chip 20 of the RFID packaging material carries a unique ID (identification) code, the authenticity of the product packaged with the RFID packaging material can be recognized by means of a RFID scanner.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method for anti-fake package of RFID, comprising the steps of:
providing a substrate having a conductive layer covered thereon;
processing said conductive layer to form an antenna;
mounting a RFID chip in said substrate for electrically connecting the chip to said antenna via a pad; and
covering said substrate onto a product.

2. The RFID packaging material packaging method as claimed in claim 1, wherein the metal layer of said substrate is aluminum or tin.

3. The RFID packaging material packaging method as claimed in claim 1, wherein said substrate is an inner packaging material for cigarette package.

4. The RFID packaging material packaging method as claimed in claim 1, wherein said antenna is a slot antenna.

5. The RFID packaging material packaging method as claimed in claim 1, wherein said antenna is formed in said substrate at a predetermined location.

6. The RFID packaging material packaging method as claimed in claim 1, wherein the product into which said substrate is incorporated is a package of cigarettes.

7. The RFID packaging material packaging method as claimed in claim 1, wherein the product into which said substrate is incorporated is a packaged beverage.

8. The RFID packaging material packaging method as claimed in claim 1, wherein the product into which said substrate is incorporated is the cap of a bottle wine.

9. The RFID packaging material packaging method as claimed in claim 1, wherein the step of processing said substrate to form an antenna is to process said substrate through one of trimming process, etching process, stamping process and cutting process subject to a predetermined antenna pattern.

10. An anti-fake package of RFID comprising:
a substrate covered with a conductive layer for packaging a product;
an antenna formed in said substrate; and
a chip electrically connected to said antenna via a pad for receiving and transmitting data.

11. The RFID packaging material as claimed in claim 10, wherein the metal layer of said substrate is aluminum or tin.

12. The RFID packaging material as claimed in claim 10, wherein said substrate is an inner packaging material for cigarette package.

13. The RFID packaging material packaging method as claimed in claim 10, wherein said antenna is a slot antenna.

14. The RFID packaging material packaging method as claimed in claim 10, wherein said chip is a RFID (radio-frequency identification) chip.

15. The RFID packaging material packaging method as claimed in claim 10, wherein said antenna is formed in said substrate at a predetermined location.

16. The RFID packaging material packaging method as claimed in claim 10, wherein said chip is electrically connected to said antenna by an adhesive.

17. The RFID packaging material packaging method as claimed in claim 10, wherein said substrate is adapted to package cigarettes in a cigarette package.

18. The RFID packaging material packaging method as claimed in claim 10, wherein said substrate is for the packaging of beverage.

19. The RFID packaging material packaging method as claimed in claim 10, wherein said substrate is incorporated into the cap of a bottle wine.

20. The RFID packaging material packaging method as claimed in claim 10, wherein said antenna is formed in said substrate through one of trimming process, etching process, stamping process and cutting process.
